(19) United States
(12) Patent Application Publication
(10) Pub. No.: US 2005/0204865 A1
(43) Pub. Date: Sep. 22, 2005

(54) Method for extracting magnetically hard alloy nanoparticles and magnetic recording material

(75) Inventors: Hiroyuki Hirai, Minami-ashigara-shi (JP); Koukichi Waki, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FUJI PHOTO FILM CO., LTD, Kanagawa (JP)

(21) Appl. No.: 11/006,569

(22) Filed: Dec. 8, 2004

(30) Foreign Application Priority Data
Dec. 8, 2003 (JP) 2003-409087

(51) Int. Cl. H01F 1/06

(52) U.S. Cl. 75/345; 75/348; 148/300

(57) ABSTRACT

Disclosed is a method for extracting magnetically hard alloy nanoparticles, which comprises preparing a magnetic alloy nanoparticle dispersion by heating an organometallic compound containing a metal constituting a magnetically hard ordered alloy with a polyol compound having a boiling point of 150 to 350° C. and extracting magnetically hard alloy nanoparticles from the dispersion into a hydrophobic organic solvent in the presence of a hydrophobic surface modifying agent. The method can provide magnetically hard alloy nanoparticles showing almost no particle aggregation and markedly reduced load for drying.

### BACKGROUND OF THE INVENTION

1. Field of the Invention

The present invention relates to a method for extracting magnetically hard alloy nanoparticles having superior suitability for application and a high-density magnetic recording material produced by using the particles.

2. Description of the Related Art

It is required to make particle size smaller for obtaining higher magnetic recording density. As for magnetic recording media widely used as videotapes, computer tapes, disks etc., for example, noises are reduced as particle size becomes smaller, if weight of ferromagnetic substance is the same. Because CuAu type or Cu₃Au type magnetically hard ordered alloys exhibit significant crystal magnetic anisotropy due to distortion generated at the time of being ordered, and exhibit hard magnetism even if particle sizes thereof are made smaller, they are promising materials for the improvement in magnetic recording density (see, for example, Science, vol. 287, p. 1989, 2000).

Nanoparticles having an alloy composition constituting a CuAu type or Cu₃Au type magnetically hard ordered alloy immediately after the synthesis by the liquid phase method or vapor phase method show a random phase and soft magnetism or paramagnetism in many cases. In such a state, they cannot be used for magnetic recording media. In order to obtain an ordered alloy phase, it is usually necessary to anneal them at a temperature of about 500° C. However, annealing at such a temperature causes increase of the particle size due to sintering. Moreover, inhibition of phase transformation due to dispersion of impurities from a support poses a problem. Furthermore, when a support of an organic substance is used, in particular, a problem of poor adhesion of an ordered alloy layer with a support is also caused.

Jeyadevan, B., et al. synthesized FePt nanoparticles by using the polyol method (see, for example, Japan Journal of Applied Physics (Jpn. J. Appl. Phys.), vol. 42, pp. L350-L352, 2003). In particular, they demonstrated that a magnetically hard alloy having high coercive force could be directly obtained by a reaction at 300° C. in tetraethylene glycol. However, this process has problems for practical use, i.e., the polyol solvent hardly dries, and if it is attempted to remove the polyol solvent, aggregation of the particles occurs. Thus, improvement of these problems has been desired. Furthermore, it is also desired to obtain a magnetically hard alloy nanoparticles under low temperature and short-time heating conditions.

### SUMMARY OF THE INVENTION

An object of the present invention is to provide a method for extracting magnetically hard alloy nanoparticles that show little aggregation of particles, for which load of drying is markedly reduced. The object of the present invention is, in particular, to provide a method for producing CuAu type or Cu₃Au type magnetically hard alloy nanoparticle colloid. Furthermore, another object of the present invention is to provide a method for producing CuAu type or Cu₃Au type magnetically hard alloy nanoparticle colloid, which can shorten the reaction time and enables the production at a low reaction temperature.

As a result of various researches conducted in view of the aforementioned objects, it was found that a magnetically hard ordered alloy nanoparticle dispersion, for which load of drying was reduced, could be obtained by heating an organometallic compound containing a metal constituting the magnetically hard ordered alloy with a polyol compound having a boiling point of 150 to 350° C. to obtain a magnetically hard ordered alloy nanoparticle dispersion, and extracting the alloy nanoparticles into a hydrophobic organic solvent having a low boiling point, and thus the present invention was accomplished.

That is, the objects of the present invention were achieved by the followings.

(1) A method for extracting magnetically hard alloy nanoparticles, which comprises preparing a magnetic alloy nanoparticle dispersion by heating an organometallic compound containing a metal (ion) constituting a magnetically hard ordered alloy with a polyol compound having a boiling point of 150 to 350° C. and extracting magnetically hard alloy nanoparticles from the dispersion into a hydrophobic organic solvent in the presence of a hydrophobic surface modifying agent.

(2) The method for extracting magnetically hard alloy nanoparticles according to the above (1), wherein water is added to the magnetically hard alloy nanoparticle dispersion, and the hydrophobic organic solvent is further added to the dispersion.

(3) The method for extracting magnetically hard alloy nanoparticles according to the above (1), wherein a lower alcohol and/or water is added to the magnetically hard alloy nanoparticle dispersion, the mixture is filtered and/or centrifuged in the presence of the hydrophobic surface modifying agent, and a hydrophobic organic solvent is added to the precipitates.

(4) The method for extracting magnetically hard alloy nanoparticles according to any one of the above (1) to (3), wherein the organometallic compound is a compound represented by the following formula [I]: 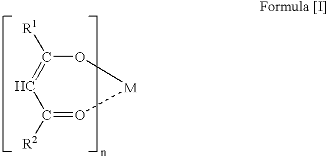
wherein R¹ and R² independently represent a substituted or unsubstituted alkyl group, a substituted or unsubstituted alkoxyl group or a substituted or unsubstituted aryl group, M represents a metal ion, and n represents valence of the metal ion.

(5) The method for extracting magnetically hard alloy nanoparticles according to any one of the above (1) to (4), wherein the organometallic compound contains Fe and/or Pt as a metal constituting the organometallic compound.

(6) The method for extracting magnetically hard alloy nanoparticles according to the above (5), wherein the organometallic compound contains at least one kind of metal selected from Cu, Co, In, Ag, Bi, Sb, Pb and Zn as a metal constituting the organometallic compound.

(7) The method for extracting magnetically hard alloy nanoparticles according to any one of the above (1) to (6), which comprises a heating step by microwave irradiation in the preparation of the magnetic alloy nanoparticle dispersion.

(8) A coating composition containing magnetically hard alloy nanoparticles prepared by using the method for extracting magnetically hard alloy nanoparticles according to any one of the above (1) to (7).

(9) A magnetic recording material produced by using the method for extracting magnetically hard alloy nanoparticles according to any one of the above (1) to (7).

By preparing a magnetically hard alloy nanoparticle dispersion through heat reduction of an organometallic compound with a polyol compound and then extracting the alloy nanoparticles into a hydrophobic organic solvent having a low boiling point in the presence of a hydrophobic surface modifying agent, a magnetically hard alloy nanoparticle dispersion for which load of drying is reduced can be obtained. Further, by attaining the heating by microwave irradiation, the magnetically hard alloy nanoparticle dispersion can be obtained in a short time.

### BRIEF DESCRIPTION OF DRAWINGS

FIG. 1 is a TEM photograph of the FePt alloy nanoparticles in the extract described in Example 1.

### BEST MODE FOR CARRYING OUT THE INVENTION

Hereafter, the method for extracting magnetically hard alloy nanoparticles and magnetic recording material of the present invention will be explained in detail. In the present specification, the numerical ranges expressed with the term “to” mean ranges including the numerals indicated before and after the term as lower limit and upper limit values.

[1] Organometallic Compound

Examples of the organometallic compound used for the method for extracting magnetically hard alloy nanoparticles of the present invention include carboxylic acid metal salts, metal/pyridine complexes, metal/bipyridyl complexes, metal carbonyl compounds, metal/oxine complexes, 1,10-phenanthroline complexes and so forth.

As the metal ion constituting the organometallic compound, Fe ion, Pt ion, Co ion, Cu ion, In ion, Ag ion, Bi ion, Sb ion, Pb ion, Zn ion and so forth are preferred. It is especially preferred that the organometallic compound contains Fe ion and/or Pt ion. The atomic valence of the metal ion is not particularly limited. Further, if nanoparticles of a binary alloy such as FePt or CoFe further contains any of the aforementioned metals as a third element, the temperature of transformation into tetragonal crystals (fct structure) is favorably reduced. The amount of the third element to be added is preferably 1 to 30 atomic %, more preferably 5 to 20 atomic %.

Preferred organometallic compounds are the compounds represented by the aforementioned formula [I]. In the formula [I], R¹ and R² independently represent a substituted or unsubstituted alkyl group (e.g., methyl group, ethyl group, n-propyl group, tert-butyl group, trifluoromethyl group, n-pentafluoropropyl group etc.), a substituted or unsubstituted alkoxyl group (methoxy group, ethoxy group etc.) or a substituted or unsubstituted aryl group. M represents a metal ion, and n represents valence of the metal ion. n is usually 1 to 6, preferably 2 to 4.

Specific examples of the compounds represented by the formula [I] include Pt(II) 2,4-pentanedionate, Pt(II) hexafluoro-2,4-pentanedionate, Fe(III) 2,4-pentanedionate, Fe(III) benzoylacetonate, Fe(III) diphenylpropanedionate, Fe(III) 1,1,1-trifluoro-2,4-pentanedionate, Fe(III) tris(2,2,6,6-tetramethyl-3,5-heptanedionate), Co(III) hexafluoro-2,4-pentanedionate, Co(III) 2,4-pentanedionate, Co(III) tris(2,2,6,6-tetramethyl-3,5-heptanedionate), Cu II) 2,4-pentanedionate, Cu(II) ethylacetoacetate, In(III) 2,4-pentanedionate, In(III) methyl(trimethyl)acetylacetate [R¹═(CH₃)₃CO—, R²═CH₃—], Ag(I) 2,4-pentanedionate, Bi(III) 2,2,6,6-tetramethyl-3,5-heptanedionate and so forth. However, the compounds represented by the formula [I] that can be used for the present invention are not limited to these compounds.

In the method for extracting magnetically hard alloy nanoparticles of the present invention, one kind of organometallic compound alone may be used, or two or more kinds of organometallic compounds may be used in combination.

[2] Polyol Compound

Examples of the polyol compound of which boiling point is 150 to 350° C. used for the method for extracting magnetically hard alloy nanoparticles of the present invention include ethylene glycol, diethylene glycol, triethylene glycol, tetraethylene glycol, propylene glycol, 1,3-propanediol, 1,2-butanediol, 1,3-butanediol, 1,4-butanediol, 2,3-butanediol, 1,5-pentanediol, 1,6-hexanediol, 2,5-hexanediol and so forth. Among these, those exhibiting a higher solubility in water than the solubility in the hydrophobic organic solvent described later are preferred. As such polyol compounds, ethylene glycol, diethylene glycol, triethylene glycol, propylene glycol, 1,3-propanediol, 1,3-butanediol and 1,4-butanediol are preferred. Moreover, the boiling point of the polyol compound is preferably 150 to 350° C., more preferably 180 to 300° C.

[3] Hydrophobic Surface Modifying Agent

Examples of the hydrophobic surface modifying agent used for the method for extracting magnetically hard alloy nanoparticles of the present invention include aliphatic carboxylic acids having 6 or more carbon atoms (e.g., octanoic acid, decanoic acid, lauric acid, myristic acid, palmitic acid, stearic acid, oleic acid etc.), aliphatic alcohols having 0.6 or more carbon atoms (e.g., 1-hexanol, 1-decanol, 1-dodecanol, 1-hexadecanol etc.), aliphatic amines having 6 or more carbon atoms (e.g., octylamine, decylamine, dodecylamine, oleoylamine etc.), and alkylthiols having 6 or more carbon atoms (e.g., dodecanethiol, octadecanethiol etc.). Among these, compounds having 10 or more carbon atoms are preferred.

[4] Hydrophobic Organic Solvent

As the hydrophobic organic solvent used for the method for extracting magnetically hard alloy nanoparticles of the present invention, those having a boiling point of 70 to 180° C. are preferred, because the load for drying of such solvents is small. Examples of such organic solvents include alkanes (e.g., heptane, octane, isooctane, decane etc.), esters (ethyl acetate, butyl acetate, propyl acetate, ethyl propionate, butyl propionate etc.), ketones (e.g., ethyl methyl ketone, diethyl ketone, butyl ethyl ketone, acetylacetone etc.), aromatic compounds (e.g., toluene, o-xylene, m-xylene, p-xylene etc.), and ethers (e.g., propyl ether, butyl ether, butyl ethyl ether etc.). Among these, alkanes, aromatic compounds and ethers exhibiting a small solubility in water are preferred.

[5] Magnetically Hard Ordered Alloy

As the ferromagnetic ordered alloy, CuAu type ferromagnetic ordered alloys and Cu₃Au type ferromagnetic ordered alloys are preferred. Examples of the CuAu type ferromagnetic ordered alloys include FeNi, FePd, FePt, CoPt and so forth, and among these, FePd, FePt and CoPt are preferred. FePt is the most preferred material, because it shows the largest magnetic anisotropy constant. Examples of the Cu₃Au type ferromagnetic ordered alloys include Ni₃Fe, FePd₃, Fe₃Pt, FePt₃, CoPt₃, Ni₃Pt, CrPt₃ and Ni₃Mn, and among these, FePd₃, FePt₃, CoPt₃, Fe₃Pd, Fe₃Pt and Co₃Pt are preferably used. Examples of the third element added to a binary alloy in order to lower the temperature of transformation into a magnetically hard ordered alloy include Sb, Pb, Zn and so forth in addition to Cu, In, Ag and Bi mentioned above.

[6] Microwave Irradiation

The heating step of the method for extracting magnetically hard alloy nanoparticles of the present invention is preferably carried out by microwave irradiation. Although frequencies of 915 MHz, 2.45 GHz, 5.8 GHz, 22.125 GHz and so forth can be used in the microwave irradiation, it is preferable to use a frequency of 2.45 GHz, which is adopted in popular machines. Although the output is not particularly limited, an output of 100 W to 10 kW is desirable, and the irradiation may be performed continuously or intermittently. The heating temperature is preferably 150 to 300° C., particularly preferably 180 to 280° C. The heating time is 10 seconds to 3 hours, preferably 1 minute to 90 minutes, after the temperature reached a predetermined temperature. Because the polyol compound used in the present invention is likely to absorb microwaves having a frequency of 2.45 GHz, use of microwaves having a frequency of 2.45 GHz enables quick heating and short time synthesis of the nanoparticles. Therefore, such microwaves can be extremely preferably used.

[7] Method for Producing Magnetically Hard Alloy Nanoparticles

In the method for extracting magnetically hard alloy nanoparticle of the present invention, a magnetic alloy nanoparticle dispersion is first prepared by heating an organometallic compound containing a metal constituting a magnetically hard ordered alloy together with a polyol compound having a boiling point of 150 to 350° C. In this process, it is preferable to dissolve the organometallic compound in the polyol compound prior to the heating. The concentration of the organometallic compound is preferably 0.1 to 1000 mM, more preferably 1 to 100 mM. By heating this solution at a temperature of from 150° C. to the boiling point of the polyol, the organometallic compound is reduced to a metal, and transformation into the fct structure is also caused. Thus, magnetically hard alloy nanoparticles can be obtained as a colloidal dispersion. Use of microwave irradiation for the heating shortens the reaction time, and thus it is preferably used. Further, during the heating, the solution can be optionally stirred or bubbled with nitrogen.

Because the polyol compound used for the method of the present invention has a high boiling point, the solution is very hard to dry when it is applied on a substrate. In the present invention, this problem is solved by changing the dispersion medium to the hydrophobic organic solvent having a low boiling point as described below.

(1) Water is added to the aforementioned dispersion of the magnetically hard alloy nanoparticles in the polyol, and the aforementioned hydrophobic organic solvent is further added to the dispersion to extract the alloy nanoparticles into the hydrophobic organic solvent in the presence of the aforementioned hydrophobic surface modifying agent and thereby form a dispersion in the hydrophobic organic solvent. Although the amount of water to be added may be optionally selected, it is preferably 50 to 500 volume % with respect to the polyol. Although the amount of the hydrophobic organic solvent to be added may also be optionally selected, it is preferably 10 to 300 volume % with respect to the polyol. The amount of the hydrophobic surface modifying agent to be added may be such an amount that the surfaces of the alloy nanoparticles should be coated with the agent, and thus the particles should be stabilized, and such an amount cannot be definitely defined, because it varies depending on the type and size of the alloy nanoparticles, type of the hydrophobic surface modifying agent and so forth. However, it is desirably 0.01 to 200 weight % with respect to the alloy nanoparticles. It is also possible to remove excessive hydrophobic surface modifying agent by washing or ultrafiltration. The hydrophobic surface modifying agent may be added to the polyol from the beginning or after the alloy nanoparticles are produced. In the latter case, the hydrophobic surface modifying agent can also be dissolved in the hydrophobic organic solvent and added.

(2) A lower alcohol (e.g., methanol, ethanol, 2-propanol etc.) and/or water is added to the aforementioned dispersion of the magnetically hard alloy nanoparticles in the polyol and filtered or centrifuged in the presence of the aforementioned hydrophobic surface modifying agent, and the aforementioned hydrophobic organic solvent is added to the obtained precipitates to extract the alloy nanoparticles into the hydrophobic organic solvent and thereby form a dispersion in the hydrophobic organic solvent. Although the amount of the lower alcohol and/or water to be added may be optionally selected, it is preferably 50 to 1000 volume % with respect to the polyol.

The hydrophobic organic solvent dispersion of the magnetically hard alloy nanoparticles obtained by one of the aforementioned methods can be concentrated by using an evaporator or the like as required.

The magnetically hard alloy nanoparticles preferably have a coercive force of 95.5 to 636.8 kA/m (1200 to 8000 Oe). When the particles are used for magnetic recording media, it is preferably 95.5 to 398 kA/m (1200 to 5000 Oe) in view of compatibility to recording heads.

The particle size of the magnetically hard alloy nanoparticles is preferably 1 to 20 nm, more preferably 3 to 10 nm. For use in magnetic recording media, closest packing of metal nanoparticles is preferred in order to obtain a higher recording capacity. To this end, the coefficient of variation of the magnetically hard alloy nanoparticles of the present invention is preferably less than 10%, more preferably 5% or less. Although the minimum stable particle size varies depending on the constituent elements, if the particle size is too small, the particles become superparamagnetic due to thermal fluctuation, and thus a too small particle size is not preferred.

A transmission electron microscope (TEM) can be used for evaluation of the particle size of the magnetically hard alloy nanoparticles. Although the crystal system of the magnetically hard alloy nanoparticles that have become magnetically hard may be determined by electron diffraction using TEM, it is preferable to use X-ray diffraction for highly precise determination. The internal composition of the magnetically hard alloy nanoparticles is preferably analyzed and evaluated by using FE-TEM that can narrow electron rays and is attached with EDAX. Magnetic properties of the magnetically hard alloy nanoparticles can be evaluated by using VSM.

The magnetically hard alloy nanoparticles of the present invention can be preferably used for magnetic recording materials such as videotapes, computer tapes, floppy® disks, hard disks and so forth by applying the particles on a support (which may have a suitable undercoat layer etc.) to form a magnetic layer having a thickness of 5 nm to 5 μm as a dry thickness. Moreover, they are also preferably used for MRAM. In such magnetic recording materials, a protective layer, lubricant layer etc. may be provided in addition to the magnetic layer.

### EXAMPLES

The characteristics of the present invention will be further specifically explained with reference to the following examples. The materials, amount used, ratios, types of procedures, orders of procedures and so forth mentioned in the following examples may be suitably altered unless such alteration depart from the gist of the present invention. Therefore, the scope of the present invention should not be construed in any limitative way on the basis of the following examples.

### Example 1

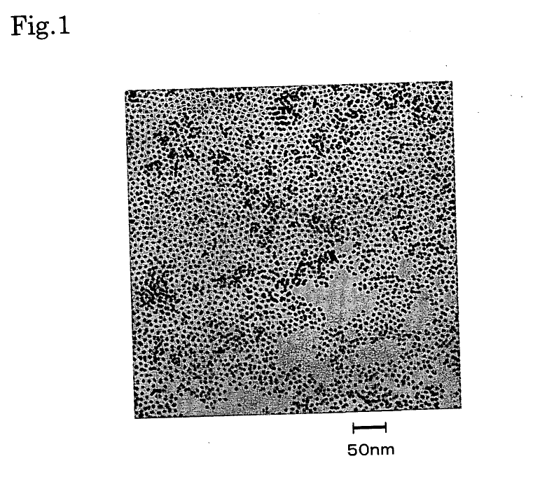

Pt(II) 2,4-pentanedionate (1.00 g) and Fe(III) 2,4-pentanedionate (0.89 g) were dissolved in tetraethylene glycol (150 ml), heated to 300° C. by irradiation of microwaves of 2.45 GHz and 650 W with nitrogen gas bubbling, and reacted at the same temperature for 50 minutes by turning on and off a microwave generator. The reaction mixture was cooled to room temperature, then added with water (300 ml) and a solution (150 ml) containing dodecanethiol (2 ml) in isooctane, and shaken for extraction. It was found by ICP and XRD analyses that the extract contained FePt alloy nanoparticles (elemental ratio: approximately 1:1, average particle size: 5.1 nm). TEM analysis showed that the FePt alloy nanoparticles in the extract contained almost no particle aggregation (see FIG. 1). The extract was concentrated to about 15 ml by using an evaporator, added with methanol (100 ml) and subjected to ultrafiltration to collect the alloy nanoparticles and remove methanol together with excessive dodecanethiol. Isooctane (10 ml) was added to the precipitates to obtain an FePt nanoparticle dispersion. When this dispersion was applied to a glass substrate, it could be easily dried, and it was found that it could be used for high-density magnetic recording materials. Magnetic properties of the synthesized particles were evaluated, and it was found that the particles changed into magnetically hard particles having an anisotropic magnetic field of 358.1 kA/m (4500 Oe).

### Example 2

Pt(II) 2,4-pentanedionate (0.79 g), Fe(III) 2,4-pentanedionate (0.71 g) and copper(II) acetate (0.18 g) were dissolved in diethylene glycol (150 ml), heated to 240° C. by irradiation of microwaves of 2.45 GHz and 650 W with nitrogen gas bubbling, and reacted (refluxed) at the same temperature for 1 hour by turning on and off a microwave generator. The reaction mixture was cooled to room temperature, then added with methanol (800 ml) containing oleic acid (2 ml), and stirred. The reaction mixture was centrifuged at 8000 rpm, and the supernatant was discarded. The precipitates were added with heptane (12 ml) for extraction. It was found by ICP and XRD analyses that the extract contained FePtCu alloy nanoparticles (elemental ratio: approximately 4:4:2, average particle size: 5.5 nm). TEM analysis showed that the FePtCu alloy nanoparticles in the extract contained almost no particle aggregation. When this extract was applied to a glass substrate, it could be easily dried, and it was found that it could be used for high-density magnetic recording materials. Magnetic properties of the synthesized particles were evaluated, and it was found that the particles changed into magnetically hard particles having an anisotropic magnetic field of 294.4 kA/m (3700 Oe).

### Example 3

When particles were produced according to the procedures of Examples 1 and 2 using a usual oil bath instead of the microwave irradiation, it took 3 to 4 hours to obtain comparable magnetically hard particles. From this result, it was found that the microwave heating enables production of magnetically hard alloy nanoparticles in a shorter time.

It was also found that if the centrifugation and extraction with heptane were not performed (i.e., in the state of a dispersion in tetraethylene glycol or diethylene glycol), the applied layer was extremely hard to dry at ordinary pressure.

The present disclosure relates to the subject matter contained in Japanese Patent Application No. 409087/2003 filed on Dec. 8, 2003, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A method for extracting magnetically hard alloy nanoparticles, which comprises preparing a magnetic alloy nanoparticle dispersion by heating an organometallic compound containing a metal constituting a magnetically hard ordered alloy with a polyol compound having a boiling point of 150 to 350° C. and extracting magnetically hard alloy nanoparticles from the dispersion into a hydrophobic organic solvent in the presence of a hydrophobic surface modifying agent.

2. The method for extracting magnetically hard alloy nanoparticles according to claim 1, wherein water is added to the magnetically hard alloy nanoparticle dispersion, and the hydrophobic organic solvent is further added to the dispersion.

3. The method for extracting magnetically hard alloy nanoparticles according to claim 1, wherein a lower alcohol and/or water is added to the magnetically hard alloy nanoparticle dispersion, the mixture is filtered and/or centrifuged in the presence of the hydrophobic surface modifying agent, and a hydrophobic organic solvent is added to the precipitates.

4. The method for extracting magnetically hard alloy nanoparticles according to claim 1, wherein the organometallic compound is a compound represented by the following formula [I]: 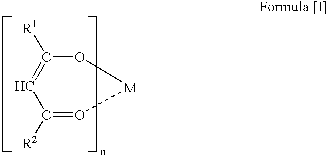
wherein R¹ and R² independently represent a substituted or unsubstituted alkyl group, a substituted or unsubstituted alkoxyl group or a substituted or unsubstituted aryl group, M represents a metal ion, and n represents valence of the metal ion.

5. The method for extracting magnetically hard alloy nanoparticles according to claim 1, wherein the organometallic compound contains Fe and/or Pt as a metal constituting the organometallic compound.

6. The method for extracting magnetically hard alloy nanoparticles according to claim 5, wherein the organometallic compound contains at least one kind of metal selected from Cu, Co, In, Ag, Bi, Sb, Pb and Zn as a metal constituting the organometallic compound.

7. The method for extracting magnetically hard alloy nanoparticles according to claim 1, which comprises a heating step by microwave irradiation in the preparation of the magnetic alloy nanoparticle dispersion.

8. A composition containing magnetically hard alloy nanoparticles prepared by using the method for extracting magnetically hard alloy nanoparticles according to claim 1.

9. A coating composition containing magnetically hard alloy nanoparticles prepared by using the method for extracting magnetically hard alloy nanoparticles according to claim 1.

10. A magnetic recording material produced by using the method for extracting magnetically hard alloy nanoparticles according to claim 1.
